(19) United States
(12) Patent Application Publication
(10) Pub. No.: US 2025/0280897 A1
(43) Pub. Date: Sep. 11, 2025

(54) Heating and Self-Cleaning Method of Smoking Set, Working Method of Smoking Set, Controller and Smoking Set

(71) Applicant: The 13th Research Institute of China Electronics Technology Group Corporation, Shijiazhuang (CN)

(72) Inventors: Chunliang XU, Shijiazhuang (CN); Hongtao WEI, Shijiazhuang (CN); Fei ZHANG, Shijiazhuang (CN); Tong LI, Shijiazhuang (CN); Junkui SONG, Shijiazhuang (CN); Xiaoliang LI, Shijiazhuang (CN); Daomin CAI, Shijiazhuang (CN)

(21) Appl. No.: 19/015,428

(22) Filed: Jan. 9, 2025

Related U.S. Application Data
(63) Continuation of application No. PCT/CN2024/095634, filed on May 28, 2024.

(30) Foreign Application Priority Data
Mar. 11, 2024 (CN) 202410271011.7

(51) Int. Cl. A24F 40/85; A24F 40/20; A24F 40/46; A24F 40/53; A24F 40/57; H05B 6/64; H05B 6/68; H05B 6/80

(52) U.S. Cl. CPC A24F 40/85; A24F 40/20; A24F 40/46; A24F 40/53; A24F 40/57; H05B 6/645; H05B 6/686; H05B 6/80

(57) ABSTRACT

The present application is applicable to the field of heating and cleaning of smoking sets technology and provides a heating and self-cleaning method of a smoking set including: after a cigarette containing a moisture is placed into the smoking set having a microwave frequency source, setting an oscillation frequency of the microwave frequency source to a first frequency to release an aromatic substance in the cigarette, wherein the first frequency is set for causing a systematic physical resonance of a water molecule resonant chain; and after the aromatic substance in the cigarette is released, setting the oscillation frequency of the microwave frequency source to a second frequency to clean the smoking set so as to evaporate a tobacco tar substance condensed inside the smoking set, wherein the second frequency is a resonant frequency of the tobacco tar substance in a microwave field.

### CROSS-REFERENCE TO RELATED APPLICATIONS

This application is a continuation application of International Application No. PCT/CN2024/095634, filed on May 28, 2024 and entitled “heating and self-cleaning method of smoking set, working method of smoking set, controller and smoking set,” which claims priority to Chinese Patent Application No. CN 202410271011.7, filed on Mar. 11, 2024 and entitled “heating and self-cleaning method of smoking set, working method of smoking set, controller and smoking set.” The disclosures of the aforementioned applications are hereby incorporated herein by reference in their entireties.

### TECHNICAL FIELD

The present application belongs to the technical field of heating and cleaning of smoking sets, and particularly relates to a heating and self-cleaning method of a smoking set, a working method of a smoking set, a controller and a smoking set.

### BACKGROUND

Usually, cigarettes are made up of tobacco, and during the heating process of cigarettes, in addition to the release of aromatic substances, the smoke condenses when encountering the low-temperature environment of the outside world, producing tobacco tar on the inner surface of the smoking set.

In addition to conventional manual cleaning, in related technologies, catalyst is coated inside the heating body or heating cavity of the smoking set, and electrical energy is used to induce chemical bond breaking reactions of tar molecules on the active sites of the catalyst at low temperatures. Under the condition of avoiding secondary reactions of tar, tar is cracked into small molecule gases, thereby achieving the cleaning of residual tar in the heating cavity. Tobacco tar itself is a mixture of multiple chemical components, and cracking can produce new chemical components. In high-temperature environments, different components can also form new compounds, which have great potential hazards. In another related technology, an electronic cigarette product based on e-liquid with a cleaning effect is provided, which adopts a microporous filter with pre-set heating wires, has a relatively complex structure, and does not support tobacco cigarettes.

In the above cleaning methods, the cracking of tobacco tar produces new pollutants, resulting in incomplete cleaning, cleaning consumables, and the high complexity of the smoking set.

### SUMMARY

These and other problems are generally solved or circumvented, and technical advantages are generally achieved, by embodiments of the present application which provide a heating and self-cleaning method of a smoking set, a working method of a smoking set, a controller and a smoking set.

### Technical Problems

To overcome the problems existing in related technologies, the present application provides a heating and self-cleaning method of a smoking set, a working method of a smoking set, a controller and a smoking set, which can achieve the cleaning and removal of residual smoking tar in smoking set by controlling the frequency source inside the microwave heated non-burning smoking set, based on the effects of cigarettes and tobacco tar under different frequency microwave fields.

### Technical Solutions

The present application is implemented through the following technical solution:

In a first aspect, embodiments of the present application provide a heating and self-cleaning method by a smoking set, including: after a cigarette containing a moisture is placed into the smoking set having a microwave frequency source, setting an oscillation frequency of the microwave frequency source to a first frequency to release an aromatic substance in the cigarette, where the first frequency is set for causing a systematic physical resonance of a water molecule resonant chain; and after the aromatic substance in the cigarette is released, setting the oscillation frequency of the microwave frequency source to a second frequency to clean the smoking set so as to evaporate a tobacco tar substance condensed inside the smoking set, where the second frequency is a resonant frequency of the tobacco tar substance in a microwave field.

In one possible implementation, a range of the first frequency is from 915 MHz to 183 GHz.

In one possible implementation, the first frequency is 915 MHz, 2450 MHz, 5.8 GHZ, 22.235 GHz, 50.3 GHZ, 51.8 GHz, 65 GHz, 98 GHz, or 183 GHz.

In a second aspect, embodiments of the present application provide a working method by a smoking set, including: in a first working mode of the smoking set: after a cigarette lighting mode of the smoking set is selected by a user, setting an oscillation frequency of a microwave frequency source of the smoking set to a first frequency and performing a cigarette lighting workflow to light a cigarette placed in the smoking set, where the first frequency is set for causing a systematic physical resonance of a water molecule resonant chain; and after a self-cleaning mode of the smoking set is selected by the user, setting the oscillation frequency of the microwave frequency source to a second frequency and performing a cleaning workflow to clean the smoking set, where the second frequency is a resonant frequency of a tobacco tar substance in a microwave field and is set for causing the tobacco tar substance condensed inside the smoking set to evaporate.

In one possible implementation, the working method by the smoking set further includes: in a second working mode of the smoking set: after the cigarette lighting mode starts, setting the oscillation frequency of the microwave frequency source to the first frequency and performing the cigarette lighting workflow; and after the cigarette lighting mode ends, automatically entering the self-cleaning mode, automatically setting the oscillation frequency of the microwave frequency source to the second frequency and performing the cleaning workflow.

In one possible implementation, the working method by the smoking set further includes: in a third working mode of the smoking set: after the cigarette lighting mode starts, setting the oscillation frequency of the microwave frequency source to the first frequency to preheat the cigarette placed in the smoking set; after preheating the cigarette, determining a smoking situation of the user smoking the cigarette using the smoking set; and based on the smoking situation of the user, setting the oscillation frequency of the microwave frequency source, and starting to time a smoking time and to count a number of suctions simultaneously, where when the smoking time meets a preset time or the number of suctions meets a preset number of times, the smoking set stops working; and when the smoking time does not meet the preset time and the number of suctions does not meet the preset number of times, the smoking set continues to time the smoking time and to count the number of suctions.

In one possible implementation, based on the smoking situation of the user, setting the oscillation frequency of the microwave frequency source includes: when detecting that the user smokes, maintaining the oscillation frequency of the microwave frequency source at the first frequency to heat the cigarette to maintain a temperature of the cigarette and a continuous smoke generation during a suction process; and when detecting that the user does not smoke, setting the oscillation frequency of the microwave frequency source to the second frequency to perform the cleaning workflow to remove the tobacco tar substance generated during a smoking process.

In one possible implementation, determining the smoking situation of the user includes: determining the smoking situation of the user through an internal sensor, where the internal sensor is configured to monitor a temperature change of the smoking set.

In a third aspect, embodiments of the present application provide a controller, where the controller is configured to perform the heating and self-cleaning method of the smoking set as described in the first aspect or the working method of the smoking set as described in the second aspect.

In a fourth aspect, embodiments of the present application provide a smoking set including a microwave frequency source and a controller as described in the third aspect.

It is apparent to those of ordinary skill in the art that the general description above and the detailed description in the following text are only illustrative and explanatory, and cannot limit this specification.

### Advantageous Effects of the Disclosure

The beneficial effects of the embodiments of the present application compared to the prior art are:

The heating and self-cleaning method of the smoking set provided in the embodiments of the present application achieves the release of aromatic substances in cigarettes by utilizing the oscillation friction heat of water molecules under the radiation field of the microwave oscillation frequency source at the first frequency. Tobacco tar is an extremely complex mixture composed of hydrocarbons, hydrocarbon oxides, sulfides, and nitrides. Its resonant frequency in a microwave field is the second frequency, and it generates heat through molecular oscillation and friction, promoting the volatilization of tobacco tar and reducing the residual harmful substances, achieving the purpose of self-cleaning of the smoking set. And, in this method, only a microwave frequency source is added inside the smoking set, reducing the structural complexity of the smoking set.

It can be understood that the beneficial effects of the second to fourth aspects mentioned above can be found in the relevant description of the first aspect mentioned above, and will not be repeated here.

### BRIEF DESCRIPTION OF THE DRAWINGS

In order to provide a clearer explanation of the technical solution in the embodiments of the present application, a brief introduction will be given below to the accompanying drawings required in the embodiments or prior art descriptions. It is evident that the accompanying drawings in the following description are only some embodiments of the present application. For those skilled in the art, other accompanying drawings can be obtained based on these drawings without the need for creative labor.

FIG. 1 is a flowchart of a heating and self-cleaning method of a smoking set provided in an embodiment of the present application;

FIG. 2 is a schematic diagram of a three-dimensional chemical structure of 3,4-benzo[a] pyrene provided in an embodiment of the present application;

FIG. 3 is a flowchart of a first working mode provided in an embodiment of the present application;

FIG. 4 is a flowchart of a second working mode provided in an embodiment of the present application;

FIG. 5 is a flowchart of a third working mode provided in an embodiment of the present application; and

FIG. 6 is a structural schematic diagram of a controller provided in an embodiment of the present application.

### DETAILED DESCRIPTION OF ILLUSTRATIVE EMBODIMENTS

In the following description, specific details such as specific system architecture, technology, etc. are proposed for the purpose of illustration rather than limitation, in order to thoroughly understand the embodiments of the present application. However, those skilled in the art should be aware that this application can also be implemented in other embodiments without these specific details. In other cases, detailed descriptions of well-known systems, devices, circuits, and methods may be omitted to avoid unnecessary details hindering the description of the present application.

It is apparent to those of ordinary skill in the art that when used in the present application and the accompanying claims, the term “including” indicates the presence of the described features, whole, step, operation, elements, and/or components, but does not exclude the presence or addition of one or more other features, whole, step, operation, elements, components, and/or sets thereof.

It is apparent to those of ordinary skill in the art that the terms “and/or” used in the description of the present application and the accompanying claims refer to any combination and all possible combinations of one or more of the related listed items, and include these combinations.

As used in the description of the present application and the accompanying claims, the term “if” may be interpreted in context as “when” or “once” or “in response to determination” or “in response to detection”. Similarly, the phrases “if determined” or “if detected [described condition or event]” can be interpreted according to context as meaning “once determined” or “in response to determination” or “once detected [described condition or event]” or “in response to detected [described condition or event]”.

Furthermore, in the description of the present application and the accompanying claims, the terms “first”, “second”, “third”, etc. are only used to distinguish the description and cannot be understood as indicating or implying relative importance.

The reference to “one embodiment” or “some embodiments” described in the description of the present application means that specific features, structures, or features described in conjunction with the embodiments are included in one or more embodiments of the present application. Therefore, the statements “in one embodiment”, “in some embodiments”, “in other embodiments”, “in other embodiments”, etc. that appear differently in this description do not necessarily refer to the same embodiment, but rather mean “one or more but not all embodiments”, unless otherwise emphasized. The terms “including”, “containing”, “having”, and their variations all mean “including but not limited to”, unless otherwise emphasized.

During the heating and burning process of tobacco, the volatile components of the tobacco in the cigarette will be released at high temperatures, forming smoke. During the process of generation, diffusion, and transmission, smoke condenses in low-temperature environments and adheres to the inner surface of the smoking set, resulting in the production of tobacco tar. Tobacco tar contains an extremely complex mixture of hydrocarbons and hydrocarbon oxides, sulfides, and nitrides, including benzopyrene, cadmium, arsenic, beta naphthalene, amines, nitrosamines, and various carcinogens as well as carcinogenic substances such as phenols and fumaric acid. To reduce the harm to tobacco users, it is necessary to regularly clean smoking sets and minimize the residue of harmful substances.

The cleaning of the heating cavity inside existing smoking sets can be achieved through physical cleaning using tools such as brushes and cleaning balls, or by dissolving and cleaning tar with chemical reagents, or by reheating the smoking sets to a higher temperature to evaporate tar, or by using methods such as catalytic cracking. The above methods have problems such as incomplete cleaning, time-consuming and labor-intensive processes, chemical reagents that can easily damage equipment, high electricity consumption, secondary coking of tar at high temperatures to form stubborn impurities, and the generation of new harmful substances.

This application utilizes the principle of microwave heating non-burning for smoking sets, aiming at the effects of tobacco and tobacco tar under different frequency microwave fields. By controlling the frequency source inside the microwave heated non-burning smoking sets, the cleaning and removal of residual tobacco tar inside the smoking sets is achieved.

The following provides further detailed explanations of the present application in conjunction with the accompanying drawings and specific implementation methods.

FIG. 1 is a schematic diagram of a heating and self-cleaning method of a smoking set provided in an embodiment of the present application. Referring to FIG. 1, the heating and self-cleaning method of the smoking set is described in detail as follows:

Embodiments of the present application provide a heating and self-cleaning method of a smoking set, including:

Step 101, after a cigarette containing a moisture is placed into the smoking set having a microwave frequency source, setting an oscillation frequency of the microwave frequency source to a first frequency to release an aromatic substance in the cigarette, where the first frequency is set for causing a systematic physical resonance of a water molecule resonant chain, and the microwave frequency source is set inside the smoking set.

Step 102, after the aromatic substance in the cigarette is released, setting the oscillation frequency of the microwave frequency source to a second frequency to clean the smoking set so as to evaporate a tobacco tar substance condensed inside the smoking set, where the second frequency is a resonant frequency of the tobacco tar substance in a microwave field.

The present application considers that tobacco in cigarettes contains water. Water molecule is a polar molecule composed of two O—H bonds at an angle of 104.5° to each other. Water molecule has a large dipole moment (about 1.84D) and its oscillation (libration) spectrum has extremely high frequency. Through research, a systematic physical resonance can be generated in the water molecule resonant chain. Therefore, the smoking set in the present application can set the oscillation frequency of the microwave frequency source to the first frequency, and use the water molecule oscillation friction heat under the radiation field of the microwave frequency source to achieve the release of aromatic substances in tobacco. The oscillation frequency is an important parameter that describes the vibration characteristics of an object.

Under the influence of heating effect, the tobacco tar substances in tobacco are simultaneously released in small amounts. However, the condensation of the tobacco tar substances can contaminate the interior of the smoking set and requires timely cleaning.

Considering that tobacco tar is an extremely complex mixture composed of hydrocarbons and hydrocarbon oxides, sulfides, and nitrides, the International Agency for Research on Cancer has determined that the content of benzo[a] pyrene BaP in tobacco smoke is 10-50 mg/m³. 3,4-benzo[a] pyrene in tobacco tar is the most potent carcinogen, with a chemical formula of C₂₀H₁₂, a melting point of 179° C., a boiling point of 495° C., and a polarizability of 35.8×10⁻²⁴ cm³. The polarizability of water is 1.5×10⁻²⁴ cm³, and the relative density of 3,4-benzo[a] pyrene in tobacco tar is 1.35 g/cm³. 3,4-benzo[a] pyrene is insoluble in water, slightly soluble in ethanol and methanol, and soluble in benzene, toluene, xylene, chloroform, ether, and acetone, etc.

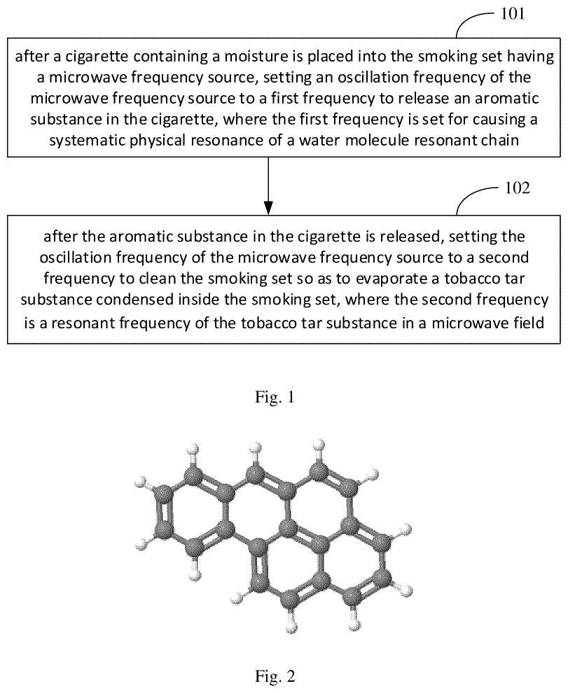

The three-dimensional chemical structure of 3,4-benzo[a] pyrene, as shown in FIG. 2, has polar molecules with non-overlapping positive and negative charge centers. A macroscopic dielectric composed of polar molecules, although each molecule generates an electric field, in the absence of an external electric field, due to the random orientation of the molecular electric dipole moment, the dielectric does not excite an electric field externally. Molecular polarizability is used to quantitatively represent the size of molecular deformation. The size of the molecular deformation refers to the displacement of the positive center and the negative center, that is, the positive center and the negative center change from coincidence to non-coincidence, and the dipole length increases from small to large. When there is an external electric field, the molecular electric dipole moment generally aligns along the direction of the electric field; the stronger the external electric field, the more orderly the arrangement.

For example, when the smoking set operates in the ISM (Industrial Scientific Medical) frequency range of 2.4 GHz to 2.5 GHz and heats the cigarette, the first frequency of the microwave oscillation source is 2.45 GHz, which is the resonant frequency of water molecules. The resonant frequency of C₂₀H₁₂ in the ISM frequency range is the second frequency. Due to its much higher polarizability than water molecules, the molecular structure of C₂₀H₁₂ is much larger than that of water molecules, resulting in selective heating and accelerating the volatilization of harmful substances such as C₂₀H₁₂.

In this embodiment, a range of the first frequency f1 is from 915 MHz to 183 GHz.

Preferably, the first frequency f1 may be 915 MHz, 2450 MHZ, 5.8 GHz, 22.235 GHZ, 50.3 GHZ, 51.8 GHz, 65 GHz, 98 GHz, or 183 GHz.

It can be seen that the heating and self-cleaning method of the smoking set provided in the embodiments of the present application achieves the release of aromatic substances in cigarettes by utilizing the oscillation friction heat of water molecules under the radiation field of the microwave oscillation frequency source at the first frequency f1. Tobacco tar is an extremely complex mixture composed of hydrocarbons, hydrocarbon oxides, sulfides, and nitrides. Its resonant frequency in a microwave field is the second frequency f2, and it generates heat through molecular oscillation and friction, promoting the volatilization of tobacco tar and reducing the residual harmful substances, achieving the purpose of self-cleaning of the smoking set. And, in this method, only a microwave frequency source is added inside the smoking set, reducing the structural complexity of the smoking set.

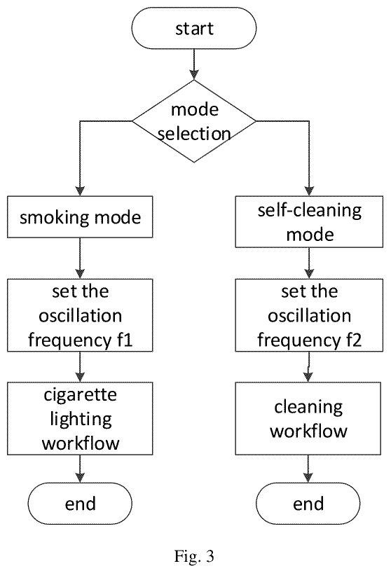

Embodiments of the present application also provide a working method of a smoking set, which has three working modes. Referring to FIG. 3, the method includes:

In a first working mode:

After a cigarette lighting mode of the smoking set is selected by a user, setting an oscillation frequency of a microwave frequency source of the smoking set to a first frequency and performing a cigarette lighting workflow to light a cigarette placed in the smoking set, where the first frequency is set for causing a systematic physical resonance of a water molecule resonant chain.

After a self-cleaning mode of the smoking set is selected by the user, setting the oscillation frequency of the microwave frequency source to a second frequency and performing a cleaning workflow to clean the smoking set, where the second frequency is a resonant frequency of a tobacco tar substance in a microwave field and is set for causing the tobacco tar substance condensed inside the smoking set to evaporate.

In the first working mode, the user selects the cigarette lighting mode or self-cleaning mode through the user interface, and executes the specific process through the internal controller of the smoking set. After the user selects the cigarette lighting mode, the controller sets the oscillation frequency of the microwave frequency source to the first frequency f1, and performs the normal cigarette lighting workflow until the preset number of suctions or the preset time is reached, and the cigarette lighting workflow ends. The preset number of suctions or the preset time should be set appropriately according to the burning time of tobacco. After the user selects the self-cleaning mode, the controller sets the oscillation frequency of the microwave frequency source to the second frequency f2 and carries out the cleaning workflow until the preset time is reached, and the cleaning workflow ends.

Among them, when entering the cigarette lighting mode or the self-cleaning mode, there will be sound vibration prompts, light prompts, or voice prompts.

In this embodiment, in the first working mode, users can choose to light a cigarette or clean according to their own wishes.

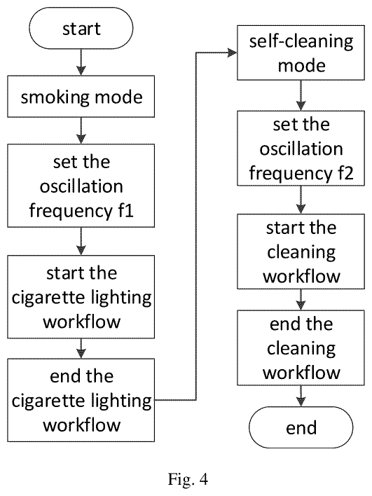

Referring to FIG. 4, the working method of the smoking set also includes:

In a second working mode:

After the cigarette lighting mode starts by the user, setting the oscillation frequency of the microwave frequency source to the first frequency and performing the cigarette lighting workflow.

After the cigarette lighting mode ends, automatically entering the self-cleaning mode, automatically setting the oscillation frequency of the microwave frequency source to the second frequency and performing the cleaning workflow.

The second working mode is a ready to use and clean workflow. After the user turns on the cigarette lighting mode, the controller inside the smoking set sets the oscillation frequency of the microwave frequency source to the first frequency f1, and the cigarette lighting workflow begins. When the cigarette lighting workflow ends, it immediately enters the self-cleaning mode, and the controller automatically sets the oscillation frequency of the microwave frequency source to the second frequency f2 until it finally ends, completing one use of the smoking set.

In this embodiment, in the second working mode, automatic cleaning can be performed after cigarette lighting, simplifying user's operations and saving user's time.

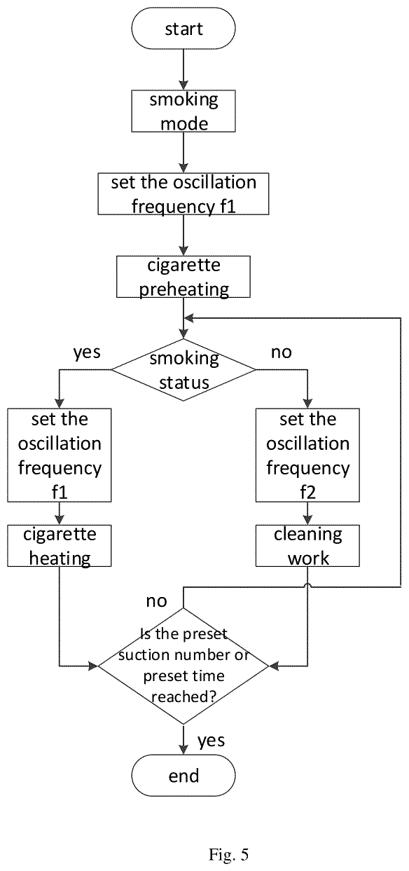

Referring to FIG. 5, the working method of the smoking set also includes:

In a third working mode:

After the cigarette lighting mode starts by the user, setting the oscillation frequency of the microwave frequency source to the first frequency to preheat the cigarette placed in the smoking set.

After preheating the cigarette, determining a smoking situation of the user smoking the cigarette using the smoking set.

For example, determining the smoking situation of the user includes: determining the smoking situation of the user through an internal sensor, where the internal sensor is configured to monitor a temperature change of the smoking set. Based on the smoking situation of the user, setting the oscillation frequency of the microwave frequency source, and starting to time a smoking time and to count a number of suctions simultaneously; where when the smoking time meets a preset time or the number of suctions meets a preset number of times, the smoking set stops working; and when the smoking time does not meet the preset time and the number of suctions does not meet the preset number of times, the smoking set continues to time the smoking time and to count the number of suctions.

Among them, one or more internal sensors are also used to monitor changes in the temperature and other parameter characteristics of the smoking set, such as infrared characteristics, impedance characteristics, current, air flow, etc.

For example, based on the smoking situation of the user, setting the oscillation frequency of the microwave frequency source includes: when detecting that the user smokes, maintaining the oscillation frequency of the microwave frequency source at the first frequency to heat the cigarette to maintain a temperature of the cigarette and a continuous smoke generation during a suction process; and when detecting that the user does not smoke, setting the oscillation frequency of the microwave frequency source to the second frequency to perform the cleaning workflow to remove the tobacco tar substance generated during a smoking process.

The third working mode is an alternating workflow of cigarette lighting and self-cleaning. When the user turns on this mode, the controller inside the smoking set sets the oscillation frequency of the microwave frequency source to the first frequency f1, and preheats the cigarette according to a set time. Among them, in the first and second working modes, the controller inside the smoking set can also set the oscillation frequency of the microwave frequency source to the first frequency f1 in advance, and preheat the cigarettes according to the set time.

In the third working mode, after preheating is completed, at least one characteristic change such as temperature, infrared characteristics, impedance characteristics, current, and air flow can be comprehensively judged by internal sensors to determine whether the user is smoking. If smoking, the controller will maintain the oscillation frequency of the microwave frequency source at the first frequency f1 to heat the cigarette, thereby maintaining the temperature of the cigarette and the release of aromatic substances, and maintaining continuous smoke generation during the suction process.

At the same time, by timing the smoking time and counting the number of suctions, if the timing and counting conditions are not met, the internal sensor will continue to perform suction judgment. If not smoking, the controller sets the oscillation frequency of the microwave frequency source to the second frequency f2 for cleaning work, removing the tobacco tar generated during the smoking process, thus achieving the effect of cleaning after each suction. Until the preset number of suctions is reached, the third working mode ends, or if the number of suctions has not been reached the preset number of times but the preset smoking time is reached, the third working mode ends, reducing the user's smoking time.

In this embodiment, in the third working mode, cleaning work can be carried out during the suction process. After smoking a cigarette or smoking a cigarette once, there is no need to clean again. Compared with the first and second working modes, the number of cleaning times is increased, the cleaning time for tobacco tar is more timely, and the cleaning force is stronger.

It can be seen that the working method of the smoking set in the present application, through the setting of three working modes, realizes different ways of free selection, instant using and instant cleaning, and alternating between cigarette lighting and self-cleaning, which can meet the needs of different users, as well as the diverse and multi scenario needs of users.

An embodiment of the present application also provides a controller for executing the heating and self-cleaning method of the smoking set and/or the working method of the smoking set as described in the above embodiment.

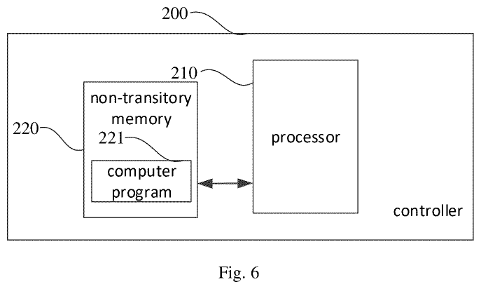

An embodiment of the present application also provides a controller, as shown in FIG. 6. The controller 200 may include at least one processor 210 and a non-transitory memory 220. The memory 220 stores a computer program 221 that may run on at least one processor 210. When the processor 210 executes the computer program 221, it implements any of the steps described in the above method embodiments.

By way of example, the computer program 221 may be divided into one or more modules/units, which are stored in the memory 220 and executed by the processor 210 to complete the present application. One or more modules/units can be a series of computer program segments capable of performing specific functions, which are used to describe the execution process of the computer program 221 in the controller 200.

Technicians in this field can understand that FIG. 6 is only an example of a controller and does not constitute a limitation on the controller. It may include more or fewer components than shown in the diagram, or combine certain components, or different components such as input/output devices, network access devices, buses, etc.

The processor 210 may be a central processing unit (CPU), as well as other general-purpose processor, digital signal processor (DSP), application specific integrated circuit (ASIC), field-programmable gate array (FPGA), or other programmable logic device, discrete gate or transistor logic device, discrete hardware component, etc. A general-purpose processor may be a microprocessor or any conventional processor.

The memory 220 may be an internal storage unit of the controller or an external storage device of the controller, such as a plug-in hard drive, smart media card (SMC), secure digital (SD) card, flash card, etc. The memory 220 is used to store computer programs and other programs and data required by the controller. The memory 220 may also be used to temporarily store data that has been or will be output.

The bus may be an industry standard architecture (ISA) bus, peripheral component interconnect (PCI) bus, or extended industry standard architecture (EISA) bus. Buses may be divided into address buses, data buses, control buses, etc. For ease of representation, the bus in the accompanying drawings of this application is not limited to only one bus or one type of bus.

The method provided in the embodiments of the present application may be applied to controllers such as computers, tablets, laptops, netbooks, personal digital assistants (PDAs), etc. The specific types of controllers are not limited by the embodiments of the present application.

An embodiment of the present application also provides a smoking set equipped with a microwave frequency source and a controller as in the above embodiment. The smoking set can achieve the functions described in the above method, and the technical effect achieved is the same as that achieved by the above method.

For example, the smoking set is also equipped with a prompt module, which is used to provide sound, vibration, light or voice prompts when entering the cigarette lighting mode or self-cleaning mode.

It is apparent to those of ordinary skill in the art that the size of the sequence numbers of each step in the above embodiments does not imply the order of execution. The execution order of each process should be determined by its function and internal logic, and should not constitute any limitation on the implementation process of embodiments of the present application.

The beneficial effects of a manufacturing method for smoking sets can be found in the beneficial effects of the heating and self-cleaning method of the smoking set in the above embodiments.

The above embodiments are only used to illustrate the technical solution of the present application, and not to limit it. Although the present application has been described in detail with reference to the aforementioned embodiments, ordinary technical personnel in the art should understand that they can still modify the technical solutions recorded in the aforementioned embodiments, or equivalently replace some of the technical features therein. And these modifications or replacements do not separate the essence of the corresponding technical solutions from the spirit and scope of the technical solutions in each embodiment of the present application, and should be included in the scope of protection of the present application.

1. A heating and self-cleaning method by a smoking set, comprising:
after a cigarette containing a moisture is placed into the smoking set having a microwave frequency source, setting an oscillation frequency of the microwave frequency source to a first frequency to release an aromatic substance in the cigarette, wherein the first frequency is set for causing a systematic physical resonance of a water molecule resonant chain; and
after the aromatic substance in the cigarette is released, setting the oscillation frequency of the microwave frequency source to a second frequency to clean the smoking set so as to evaporate a tobacco tar substance condensed inside the smoking set, wherein the second frequency is a resonant frequency of the tobacco tar substance in a microwave field.

2. The heating and self-cleaning method according to claim 1, wherein a range of the first frequency is from 915 MHz to 183 GHz.

3. The heating and self-cleaning method according to claim 2, wherein the first frequency is 915 MHz, 2450 MHz, 5.8 GHz, 22.235 GHz, 50.3 GHZ, 51.8 GHz, 65 GHz, 98 GHz, or 183 GHz.

4. A working method by a smoking set, comprising:
in a first working mode of the smoking set:
after a cigarette lighting mode of the smoking set is selected by a user, setting an oscillation frequency of a microwave frequency source of the smoking set to a first frequency and performing a cigarette lighting workflow to light a cigarette placed in the smoking set, wherein the first frequency is set for causing a systematic physical resonance of a water molecule resonant chain; and
after a self-cleaning mode of the smoking set is selected by the user, setting the oscillation frequency of the microwave frequency source to a second frequency and performing a cleaning workflow to clean the smoking set, wherein the second frequency is a resonant frequency of a tobacco tar substance in a microwave field and is set for causing the tobacco tar substance condensed inside the smoking set to evaporate.

5. The working method according to claim 4, further comprising:
in a second working mode of the smoking set:
after the cigarette lighting mode starts, setting the oscillation frequency of the microwave frequency source to the first frequency and performing the cigarette lighting workflow; and
after the cigarette lighting mode ends, automatically entering the self-cleaning mode, automatically setting the oscillation frequency of the microwave frequency source to the second frequency and performing the cleaning workflow.

6. The working method according to claim 5, further comprising:
in a third working mode of the smoking set:
after the cigarette lighting mode starts, setting the oscillation frequency of the microwave frequency source to the first frequency to preheat the cigarette placed in the smoking set;
after preheating the cigarette, determining a smoking situation of the user smoking the cigarette using the smoking set; and
based on the smoking situation of the user, setting the oscillation frequency of the microwave frequency source, and starting to time a smoking time and to count a number of suctions simultaneously, wherein when the smoking time meets a preset time or the number of suctions meets a preset number of times, the smoking set stops working; and when the smoking time does not meet the preset time and the number of suctions does not meet the preset number of times, the smoking set continues to time the smoking time and to count the number of suctions.

7. The working method according to claim 6, wherein based on the smoking situation of the user, setting the oscillation frequency of the microwave frequency source comprises:
when detecting that the user smokes, maintaining the oscillation frequency of the microwave frequency source at the first frequency to heat the cigarette to maintain a temperature of the cigarette and a continuous smoke generation during a suction process; and
when detecting that the user does not smoke, setting the oscillation frequency of the microwave frequency source to the second frequency to perform the cleaning workflow to remove the tobacco tar substance generated during a smoking process.

8. The working method according to claim 6, wherein determining the smoking situation of the user comprises:
determining the smoking situation of the user through an internal sensor, wherein the internal sensor is configured to monitor a temperature change of the smoking set.

9. The working method according to claim 4, further comprising:
in a third working mode of the smoking set:
after the cigarette lighting mode starts, setting the oscillation frequency of the microwave frequency source to the first frequency to preheat a cigarette placed in the smoking set;
after preheating the cigarette, determining a smoking situation of a user smoking the cigarette using the smoking set; and
based on the smoking situation of the user, setting the oscillation frequency of the microwave frequency source, and starting to time a smoking time and to count a number of suctions simultaneously, wherein when the smoking time meets a preset time or the number of suctions meets a preset number of times, the smoking set stops working; and when the smoking time does not meet the preset time and the number of suctions does not meet the preset number of times, the smoking set continues to time the smoking time and to count the number of suctions.

10. The working method according to claim 9, wherein based on the smoking situation of the user, setting the oscillation frequency of the microwave frequency source comprises:
when detecting that the user smokes, maintaining the oscillation frequency of the microwave frequency source at the first frequency to heat the cigarette to maintain a temperature of the cigarette and a continuous smoke generation during a suction process; and
when detecting that the user does not smoke, setting the oscillation frequency of the microwave frequency source to the second frequency to perform the cleaning workflow to remove the tobacco tar substance generated during a smoking process.

11. The working method according to claim 9, wherein determining the smoking situation of the user comprises:
determining the smoking situation of the user through an internal sensor, wherein the internal sensor is configured to monitor a temperature change of the smoking set.

12. The working method according to claim 4, wherein a range of the first frequency is from 915 MHz to 183 GHz.

13. The working method according to claim 12, wherein the first frequency is 915 MHz, 2450 MHz, 5.8 GHz, 22.235 GHz, 50.3 GHZ, 51.8 GHz, 65 GHz, 98 GHz, or 183 GHz.

14. A controller, wherein the controller is configured to perform the heating and self-cleaning method by the smoking set according to claim 1.

15. A controller, wherein the controller is configured to perform the working method by the smoking set according to claim 4.

16. A smoking set comprising a microwave frequency source and the controller according to claim 14.

17. A smoking set comprising a microwave frequency source and the controller according to claim 15.
